(19) United States
(12) Patent Application Publication
(10) Pub. No.: US 2024/0290014 A1
(43) Pub. Date: Aug. 29, 2024

(54) AI-ENABLED ULTRA-LOW-DOSE CT RECONSTRUCTION

(71) Applicant: RENSSELAER POLYTECHNIC INSTITUTE, Troy, NY (US)

(72) Inventors: Ge Wang, Loudonville, NY (US); Weiwen Wu, Shenzhen (CN); Chuang Niu, Troy, NY (US)

(73) Assignee: RENSSELAER POLYTECHNIC INSTITUTE, Troy, NY (US)

(21) Appl. No.: 18/569,764

(22) PCT Filed: Jun. 17, 2022
(86) PCT No.: PCT/US2022/033918

§ 371 Date: Dec. 13, 2023

Related U.S. Application Data
(60) Provisional application No. 63/211,827, filed on Jun. 17, 2021.

(51) Int. Cl. G06T 11/00; G06T 3/4046; G06T 3/4053

(52) U.S. Cl. CPC G06T 11/006; G06T 3/4046; G06T 3/4053; G06T 2211/421; G06T 2211/441; G06T 2211/444

(57) ABSTRACT

In one embodiment, there is provided an apparatus for ultra-low-dose (ULD) computed tomography (CT) reconstruction. The apparatus includes a low dimensional estimation neural network, and a high dimensional refinement neural network. The low dimensional estimation neural network is configured to receive sparse sinogram data, and to reconstruct a low dimensional estimated image based, at least in part, on the sparse sinogram data. The high dimensional refinement neural network is configured to receive the sparse sinogram data and intermediate image data, and to reconstruct a relatively high resolution CT image data. The intermediate image data is related to the low dimensional estimated image.

### CROSS REFERENCE TO RELATED APPLICATION(S)

This application claims the benefit of U.S. Provisional Application No. 63/211,827, filed Jun. 17, 2021, which is incorporated by reference as if disclosed herein in its entirety.

### GOVERNMENT LICENSE RIGHTS

This invention was made with government support under award numbers CA237267, and HL151561, both awarded by the National Institutes of Health (NIH). The government has certain rights in the invention.

### FIELD

The present disclosure relates to ultra-low-dose (ULD) computed tomography (CT) reconstruction, in particular to, AI (artificial intelligence)-enabled ULD CT reconstruction.

### BACKGROUND

Chest CT is a commonly performed imaging modality second only to chest radiography. There is a several-fold difference between radiation doses associated with chest CT relative to chest radiography. Until recently, use of chest CT in the United States (US) was limited to symptomatic patients or those with known or suspected diseases. Since the conclusion of the National Lung cancer Screening Trial (NLST), use of chest CT has been extended to screening of asymptomatic patients who are at risk of lung cancer. The NLST demonstrated that annual screening of at-risk patients with CT is associated with 20% relative risk reduction of death from lung cancer relative to screening with chest radiography. To reduce potential risk associated with radiation dose from annual CT, a low-dose CT (LDCT) is recommended for lung cancer screening. However, the recommended target of 1.5 mSv (milliSievert) for LDCT in average-size adult patients is an order of magnitude higher than 0.1 mSv dose from two-projection (posteroanterior and lateral projections) chest radiographs.

Despite evidence for reduction of CT radiation dose by several fold relative to a current standard of care, low-dose and ultra-low dose CT protocols are often not used. For lung cancer screening LDCT, a recent study reported that nearly two-thirds of US scanner sites had median radiation doses above the recommended American College of Radiology (ACR) guidelines.

Similar to lung nodules, kidney stones are also amenable to evaluation at lower radiation dose, and yet relatively few US sites typically apply reduced dose CT protocols for assessing patients with renal colic. This trend remains despite recommendations for use of low dose CT in patients with suspected renal calculi as primary indication for their scanning. The hesitation of adopting lower radiation doses may be related to both concern over loss of diagnostic information and lack of faith in existing dose reduction technologies and image reconstruction algorithms. The limitations of current dose reduction techniques and their adoption suggests a need for better options and improvements in dose reduction and image quality optimization.

### SUMMARY

In some embodiments, there is provided an apparatus for ultra-low-dose (ULD) computed tomography (CT) reconstruction. The apparatus includes a low dimensional estimation neural network, and a high dimensional refinement neural network. The low dimensional estimation neural network is configured to receive sparse sinogram data, and to reconstruct a low dimensional estimated image based, at least in part, on the sparse sinogram data. The high dimensional refinement neural network is configured to receive the sparse sinogram data and intermediate image data, and to reconstruct a relatively high resolution CT image data. The intermediate image data is related to the low dimensional estimated image.

In some embodiments of the apparatus, each neural network includes an image reconstruction module (RM), a deep estimation module (DM), and an error correction module (EM).

In some embodiments of the apparatus, each neural network is configured to implement a split-Bregman technique.

In some embodiments, the apparatus includes a filtered back projection (FBP) module configured to produce an FBP output based, at least in part, on the sparse sinogram data. The low dimensional estimated image is reconstructed based, at least in part, on the FBP output.

In some embodiments, the apparatus includes an up-sampling module configured to produce the intermediate image data based, at least in part, on the low dimensional estimated image.

In some embodiments of the apparatus, the low dimensional estimation neural network and the high dimensional refinement neural network are trained based, at least in part, on normal dose (ND) CT image data.

In some embodiments of the apparatus,

$$the RM corresponds to$$

$${x}^{( k + 1 )} = {x}^{( k )} - {a}^{( k )} ( {A}^{T} ( A {x}^{( k )} - y ) ) - {b}^{( k )} ( {x}^{( k )} - {z}^{( k )} - {f}^{( k )} ) ,$$

$$the DM corresponds to$$

$${z}^{( k + 1 )} = Q * ( {z}_{1}^{( k )} ) = Q * ( Q ( {x}^{( k + 1 )} - {f}^{( k )} ) ) ,$$

$$and the EM corresponds to$$

$${f}^{( k + 1 )} = {f}^{( k )} - {η}^{( k + 1 )} ( {x}^{( k + 1 )} - {z}^{( k + 1 )} ) .$$

In some embodiments, there is provided a method for ultra-low-dose (ULD) computed tomography (CT) reconstruction. The method includes reconstructing, by a low dimensional estimation neural network, a low dimensional estimated image based, at least in part, on sparse sinogram data. The method further includes reconstructing, by a high dimensional refinement neural network, a relatively high resolution CT image data based, at least in part, on the sparse sinogram data and based, at least in part, on intermediate image data. The intermediate image data is related to the low dimensional estimated image.

In some embodiments of the method, each neural network includes an image reconstruction module (RM), a deep estimation module (DM), and an error correction module (EM).

In some embodiments of the method, the reconstructing by the neural networks includes implementing a split-Bregman technique.

In some embodiments, the method further includes producing, by a filtered back projection (FBP) module, an FBP output based, at least in part, on the sparse sinogram data. The low dimensional estimated image is reconstructed based, at least in part, on the FBP output.

In some embodiments, the method further includes producing, by an up-sampling module, the intermediate image data based, at least in part on the low dimensional estimated image.

In some embodiments, the method further includes training, by a training module, the low dimensional estimation neural network and the high dimensional refinement neural network based, at least in part, on normal dose (ND) CT image data.

In some embodiments of the method,

$$the RM corresponds to$$

$${x}^{( k + 1 )} = {x}^{( k )} - {a}^{( k )} ( {A}^{T} ( A {x}^{( k )} - y ) ) - {b}^{( k )} ( {x}^{( k )} - {z}^{( k )} - {f}^{( k )} ) ,$$

$$the DM corresponds to$$

$${z}^{( k + 1 )} = {Q}^{*} ( {z}_{1}^{( k )} ) = {Q}^{*} ( Q ( {x}^{( k + 1 )} - {f}^{( k )} ) ) ,$$

$$and the EM corresponds to$$

$${f}^{( k + 1 )} = {f}^{( k )} - {η}^{( k + 1 )} ( {x}^{( k + 1 )} - {z}^{( k + 1 )} ) .$$

In some embodiments, there is provided a deep learning system for ultra-low-dose (ULD) computed tomography (CT) reconstruction. The deep learning system includes a computing device, and a reconstruction module. The computing device includes a processor, a memory, an input/output circuitry, and a data store. The reconstruction module includes a low dimensional estimation neural network, and a high dimensional refinement neural network. The low dimensional estimation neural network is configured to receive sparse sinogram data, and to reconstruct a low dimensional estimated image based, at least in part, on the sparse sinogram data. The high dimensional refinement neural network is configured to receive the sparse sinogram data and intermediate image data, and to reconstruct a relatively high resolution CT image data. The intermediate image data is related to the low dimensional estimated image.

In some embodiments of the deep learning system, each neural network includes an image reconstruction module (RM), a deep estimation module (DM), and an error correction module (EM).

In some embodiments of the deep learning system, each neural network is configured to implement a split-Bregman technique.

In some embodiments of the deep learning system, the reconstruction module includes a filtered back projection (FBP) module configured to produce an FBP output based, at least in part, on the sparse sinogram data. The low dimensional estimated image is reconstructed based, at least in part, on the FBP output.

In some embodiments of the deep learning system, the reconstruction module includes an up-sampling module configured to produce the intermediate image data based, at least in part on the low dimensional estimated image.

In some embodiments of the deep learning system, the low dimensional estimation neural network and the high dimensional refinement neural network are trained based, at least in part, on normal dose (ND) CT image data.

In some embodiments, there is provided a computer readable storage device. The device has stored thereon instructions that when executed by one or more processors result in the following operations including any embodiment of the method.

### BRIEF DESCRIPTION OF DRAWINGS

The drawings show embodiments of the disclosed subject matter for the purpose of illustrating features and advantages of the disclosed subject matter. However, it should be understood that the present application is not limited to the precise arrangements and instrumentalities shown in the drawings, wherein:

FIG. 1A illustrates a functional block diagram of a deep learning system for ultra-low-dose (ULD) computed tomography (CT) reconstruction, according to several embodiments of the present disclosure;

FIG. 1B is a sketch illustrating a functional block diagram of a deep learning module that is one example of the neural networks of FIG. 1A, according to several embodiments of the present disclosure;

FIG. 2 illustrates a functional block diagram of an example encoder-decoder network, according to an embodiment of the present disclosure;

FIG. 3 is a flowchart of operations for training a deep learning system for ULD CT reconstruction, according to various embodiments of the present disclosure; and

FIG. 4 is a flowchart of operations for AI-enabled ULD CT reconstruction, according to various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure relates to artificial intelligence (AI)-enabled ultra-low-dose (ULD) computed tomography (CT) reconstruction. A method, apparatus and/or system may be configured to receive measured ULD CT data (i.e., ULD sinogram), to process the received measured data and to produce relatively high resolution image data as output. As used herein, “ultra-low-dose” means radiation exposure of less than 1.5 milliSieverts (mSv). In one nonlimiting example, ULD radiation exposure may be on the order of 0.1 mSv.

In an embodiment, a deep learning system may include a low-dimensional estimation (LE) neural network (NN) configured to receive measured input data corresponding to a ULD CT sinogram (i.e., sparse sinogram), and to process the sparse sinogram to produce LE image data. The LE image data may then be upsampled to produce intermediate image data. The deep learning system may include a high-dimensional refinement (HR) NN configured to receive the input sparse sinogram and the intermediate image data, and to produce an HR image data output based, at least in part, on the received sparse sinogram and the intermediate image data.

Each NN may correspond to a deep learning module that is configured to implement a split-Bregman optimization strategy, as will be described in more detail below. Each learning module may include an image reconstruction module (RM), a deep estimation module (DM), and an error correction module (EM). In some embodiments, each learning module may include a plurality of each type of module. Each RM is configured to perform image reconstruction. Each DM is configured to estimate a residual error between a ground truth and a reconstructed image. Each EM is configured to correct a feedback error.

The deep learning system may be trained using training data pairs that include training sinogram data and corresponding training image data. The training data pairs may be generated from normal dose (ND) CT data that includes ND sinograms and corresponding reconstructed ND image data. The training sinogram data may then correspond to sparsified ND CT sinogram data. In one nonlimiting example, sparsifying may correspond to selecting fewer than all views (i.e., “few-view”) from the ND CT sinogram data. The corresponding training image data may then be the ND image data. In other words, the ND image data may correspond to a “ground truth” reconstructed image data. Thus, each training data pair includes sparse sinogram data and corresponding relatively high resolution reconstructed image data. The deep learning system may then be trained prior to operation. After training, the method, apparatus and/or system may then be configured to provide a relatively high resolution reconstructed image based, at least in part, on ULD CT input data.

By way of theoretical background, a few-view image reconstruction task for CT may include recovering an underlying image from sparse projection data based, at least in part, on a corresponding measurement model. Let A∈ [symbol] m×N (m<<N) be a discrete-to-discrete linear transform representing a CT system from image pixels to detector readings; y∈ [symbol] ^{m} is an original measurement (i.e., sinogram), e∈ [symbol] ^{m} is data noise within y, and x∈ [symbol] ^{N} is the image to be reconstructed (i.e., image data), and m<<N signifies that the inverse is relatively highly underdetermined. H represents a sparsifying transform to enforce prior knowledge on the image. In this setting, the image reconstruction task with sparsity prior may be expressed as:

$${x}^{*} = arg {min}_{x} {‖ Hx ‖}_{0} , \qquad ( 1 )$$

$$subject to$$

$$y = Ax + e ,$$

where ∥·∥₀ represents the l₀-norm. Because Eq. (1) includes the l₀-norm optimization, a solution is NP-hard. However, it is feasible to relax the l₀-norm optimization in Eq. (1) to an l₁-norm surrogate. Eq. (1) may then be relaxed to:

$${x}^{*} = arg {min}_{x} {‖ Hx ‖}_{1} , \qquad ( 2 )$$

$$subject to$$

$$y = Ax + e .$$

In most cases of CT image reconstruction, the optimization task Eq. (2) can be solved using an iterative algorithm. A solution to Eq. (2) can be found in the set expended by H with an image generating data close to y. In other words, the optimization of Eq. (2) may be equivalent to:

$${x}^{*} = arg {min}_{x} \frac{1}{2} {‖ y - Ax ‖}_{2}^{2} + λ {‖ Hx ‖}_{1} , \qquad ( 3 )$$

where λ>0 is configured to balance data fidelity ½∥y−Ax∥₂² and the image prior ∥Hx∥₁. A goal of Eq. (3) includes finding an optimized solution by minimizing an objective function. To solve this, a split-Bregman strategy may be employed. The data fidelity and regularized prior may be split by introducing z to re-express Eq. (3) as:

$$\{ {x}^{*} , {z}^{*} \} = arg {min}_{\{ x , z \}} \frac{1}{2} {‖ y - Ax ‖}_{2}^{2} + λ {‖ H z ‖}_{1} , \qquad ( 4 )$$

$$subject to$$

$$z = x .$$

The constrained optimization may then be converted into an unconstrained optimization task by introducing an error variable f as:

$$\{ x * , z * \} = arg {min}_{\{ x , z \}} \frac{1}{2} {‖ y - Ax ‖}_{2}^{2} + \frac{{λ}_{1}}{2} {‖ x - z - f ‖}_{2}^{2} + λ {‖ Hz ‖}_{1} . \qquad ( 5 )$$

Three variables in Eq. (5), may be handled by solving the following two sub-equations alternatively:

$${x}^{( k + 1 )} = arg {min}_{x} \frac{1}{2} {‖ y - Ax ‖}_{2}^{2} + \frac{{λ}_{1}}{2} {‖ x - {z}^{( k )} - {f}^{( k )} ‖}_{2}^{2} , \qquad ( 6 )$$

$${z}^{( k + 1 )} = arg {min}_{z} \frac{{λ}_{1}}{2} {‖ {x}^{( k + 1 )} - z - {f}^{( k )} ‖}_{2}^{2} + λ {‖ Hz ‖}_{1} , \qquad ( 7 )$$

$${f}^{( k + 1 )} can be updated by {f}^{( k + 1 )} = {f}^{( k )} - η ( {x}^{( k + 1 )} - {z}^{( k + 1 )} ) and η > 0. \qquad ( 8 )$$

Subequation with x: Eq. (6) may be solved by setting the derivative to zero as:

$${A}^{T} ( Ax - y ) + {λ}_{1} ( x - {z}^{( k )} - {f}^{( k )} ) = 0 , \qquad ( 9 )$$

by adding (A^{T}A+λ₁)x^{(k)} into both sides of Eq. (9) and simplifying it, yields:

$$( {A}^{T} A + {λ}_{1} ) x = ( {A}^{T} A + {λ}_{1} ) {x}^{( k )} - {A}^{T} ( {Ax}^{( k )} - y ) - {λ}_{1} ( {x}^{( k )} - {z}^{( k )} - {f}^{( k )} ) . \qquad ( 10 )$$

x may then be updated as:

$${x}^{( k + 1 )} = {x}^{( k )} - {( {A}^{T} A + {λ}_{1} )}^{- 1} ( {A}^{T} ( {Ax}^{( k )} - y ) + {λ}_{1} ( {x}^{( k )} - {z}^{( k )} - {f}^{( k )} ) ) . \qquad ( 11 )$$

Subequation with z: Eq. (7) can be solved via soft-thresholding as:

$${z}^{( k + 1 )} = H * {g}_{\frac{2 λ}{{λ}_{1}}} ( H ( {x}^{( k + 1 )} - {f}^{( k )} ) ) , \qquad ( 12 )$$

where H* represents the adjoint of H satisfying H*H=I (the identity transform), and the soft-thresholding kernel may be defined as:

$${g}_{\frac{2 λ}{{λ}_{1}}} ( u ) = \{ \begin{matrix}0 , & \vert u \vert < \frac{2 λ}{{λ}_{1}} \\ u - sgn ( u ) \times \frac{2 λ}{{λ}_{1}} & otherwise\end{matrix} . \qquad ( 13 )$$

Eq. (5) includes three parameters that may be empirically adjusted. In an embodiment, the general iterative model may be unrolled into a feed-forward network to facilitate training in a data-driven fashion.

In an embodiment, a network architecture may correspond to a Split Unrolled Grid-like Alternative (or Additional) Reconstruction (SUGAR) Network. In an embodiment, SUGAR may correspond to an interpretable neural network architecture, combining a split iterative reconstruction scheme and an unrolling strategy configured to implement a sparse-view CT image reconstruction technique. Each iteration of the above iterative reconstruction scheme may be treated as a non-linear transform function Q embedded in a neural network block. The overall architecture may include a plurality of such deep blocks. The overall architecture may be referred to as the Split Unrolling Grid-like Alternative Reconstruction (SUGAR) network for image reconstruction.

As used herein, a relatively low-dimension domain may include 256×256 pixels and a relatively high-dimension spatial domain may include 512×512 pixels. It may be appreciated that a relatively low spatial resolution technique may miss image details, leading to compromised imaging performance.

In an embodiment, a relatively high-dimensional image may be recovered from relatively limited data, as described herein. An image reconstruction technique, according to the present disclosure, may include two reconstruction steps: a low-dimensional estimation (LE) and a high-dimensional refinement (HR). In the LE step, a low-dimensional reconstruction may be achieved with an LE network. The LE result may then be up-sampled to intermediate image data. The intermediated image data may then be provided to a HR network. The HR network is configured to provide a relatively high resolution reconstructed image data as output.

It may be appreciated that the reconstruction performance achieved by combining the image sparsity and the data consistency may be somewhat limited by lack of measurement data in the challenging cases of few-view tomography. In an embodiment, a learnable nonlinear transform may be utilized to leverage a data-driven prior to facilitate image reconstruction. It may be further appreciated that relatively well-designed neural blocks may enhance imaging performance in reference to a reconstructed image and an estimated error. An auxiliary error feedback variable may reflect information embedded in the residual image-domain, thus a network architecture, according to the present disclosure, may be configured to enhance image reconstruction in the image space with awareness of the residual error.

In one nonlimiting example, a network-based reconstruction scheme may include a network forward transform (FT) Q and a network backward transform (BT) Q*. Each transform includes a plurality of blocks. Each block may include a convolutional layer, a batch-normalization (BN) layer and a rectified linear unit (ReLU) layer. In one nonlimiting example, the first convolutional layer may include filters of size 3×3 and the following convolutional network in FT may similarly include filters of 3×3. In some embodiments, the FT may include one or more pooling layers configured to relatively deeply encode image features. Advantageously, such a design may be beneficial for extracting relatively high-dimensional features and, additionally or alternatively, may be effective to reduce the computational cost relative to a fully convolutional layer.

It may be appreciated that, BT is an inverse of the feed forward transform. In an embodiment, the BT network may have a structure similar to FT except for the use of an unpooling layer instead of the pooling layer. BT may be configured to convert compressed feature maps back to an image satisfying Q*Q(x)≈x. To facilitate the use of image features, the network architecture may include skip connections. Hence, the whole network architecture may make it feasible to recover the target image from sparse/compressed measurements.

It may be appreciated that the optimization model of Eq. (3) may be expressed as:

$$x *= {argmin}_{x} \frac{1}{2} {‖ y - Ax ‖}_{2}^{2} + λ {‖ Qx ‖}_{1} . \qquad ( 14 )$$

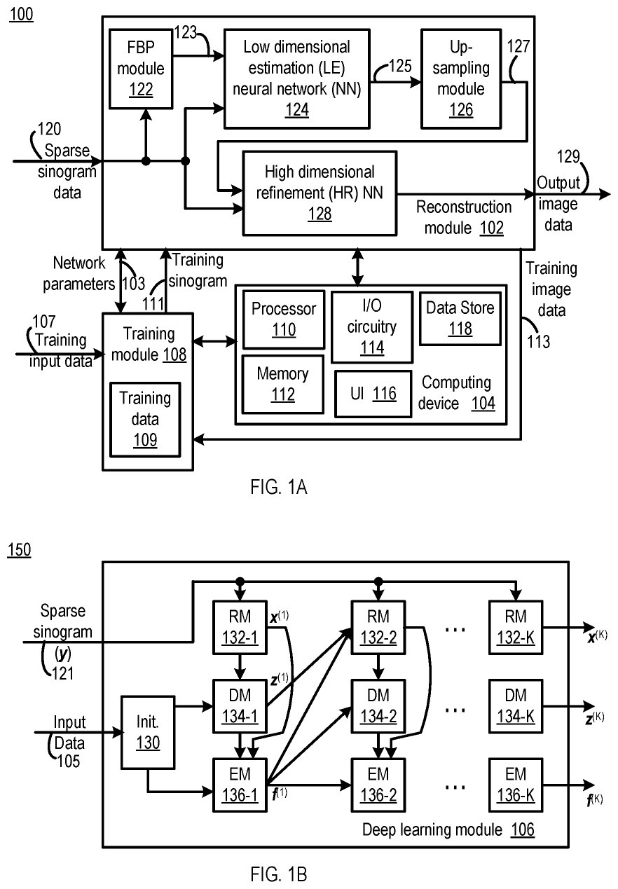

In an embodiment, a deep learning method may be configured to solve the optimization model of Eq. 14. In one nonlimiting example, each iteration of the compressed sensing algorithm may be cast to a processing module. A corresponding deep learning system may then be interpretable in a compressed sensing perspective. That is, SUGAR may be configured to update Eqs. (11), (12), and (8) by exploiting network-based transform functions. Each iteration of SUGAR is configured to include an image reconstruction module (RM), a deep estimation module (DM), and an error correction module (EM), as illustrated in FIG. 1B, described in more detail below. RM may be configured to focus on image reconstruction, DM may be configured to estimate a residual error between the ground truth and a reconstructed image, and EM may be configured to correct a feedback error.

The RM module is configured to reconstruct an image according to Eq. (11). Taking current iterates x^{(k)}, z^{(k)} and f^{(k)} as the input, an updated image x^{(k+1)} may be generated. To improve the flexibility, Eq. (11) is modified as:

$${x}^{( k + 1 )} = {x}^{( k )} - a ( {A}^{T} ( {Ax}^{( k )} - y ) ) - b ( {x}^{( k )} - {z}^{( k )} - {f}^{( k )} ) , \qquad ( 15 )$$

where a and b are two learnable parameters, which can be initially set to 1/∥A^{T}A+λ₁∥₂² and λ₁/∥A^{T}A+λ₁∥₂², respectively. These parameters may vary with respect to the iteration index. If so, Eq. (15) can be expressed as:

$${x}^{( k + 1 )} = {x}^{( k )} - {a}^{( k )} ( {A}^{T} ( {Ax}^{( k )} - y ) ) - {b}^{( k )} ( {x}^{( k )} - {z}^{( k )} - {f}^{( k )} ) . \qquad ( 16 )$$

It should be noted that x^{(k)}−z^{(k)}−f^{(k)} is the coupling term via combination of all the outputs from the current iteration. The learnable parameters a^{(k)} and b^{(k)} may be dynamically learnable as the iterative process proceeds. In Eq. (16), an update to the reconstructed image may be treated as a gradient search step, thus avoiding additional matrix inversion, with A^{T} approximated as FBP (filtered back projection), in this example.

The DM module may be configured to update the variable z that may be directly estimated via soft-thresholding, i.e., as:

$${z}^{( k + 1 )} = Q * {g}_{ϵ} ( Q ( {x}^{( k + 1 )} - {f}^{( k )} ) ) , \qquad ( 17 )$$

where ∈ represents a soft-threshold satisfying with ∈=2λ/λ₁. In an iterative reconstruction process, ∈ is a fixed constant. Eq. (17) can be decomposed into three steps: image encoding, transform filtration, and image recovery. The encoding process of the variable x^{(k+1)}−f^{(k)} is represented by the nonlinear transform function Q with the convolutional and rectified linear unit (ReLU) lavers, i.e., as:

$${z}_{1}^{( k )} = Q ( {x}^{( k + 1 )} - {f}^{( k )} ) . \qquad ( 18 )$$

Similar to the encoding process, the inverse network transform may be performed on feature maps to recover a high-quality image as:

$${z}^{( k + 1 )} = Q * ( {z}_{1}^{( k )} ) = Q * ( Q ( {x}^{( k + 1 )} - {f}^{( k )} ) ) . \qquad ( 19 )$$

It may be appreciated that the encoding-decoding process with the symmetric network-based transform functions may be viewed as an advanced version of soft-thresholding.

The EM module may be configured to implement error correction. With a dynamically adjusted updating rate η, Eq. (8) can be modified as:

$${f}^{( k + 1 )} = {f}^{( k )} - {η}^{( k + 1 )} ( {x}^{( k + 1 )} - {z}^{( k + 1 )} ) , \qquad ( 20 )$$

where η is a learnable network-specific and task-specific parameter.

A SUGAR network, according to the present disclosure, may be configured to attempt to learn a set of parameters including the step-size a^{(k)} and the coupling parameters b^{(k)} in the RM component, the parameters of the network-based nonlinear transforms Q^{(k)} and Q*^{(k)} in the DM component, as well as the step length η^{(k)} in the EM component. A deep network, according to the present disclosure, may be described by the set of parameters taking the split iterative reconstruction scheme as a special case and outperforming it with data-driven adjustments to these parameters. The measurement data y (i.e., sparse sinogram data) and the initialization of {x⁽⁰⁾, z⁽⁰⁾, f⁽⁰⁾} may be leveraged. It may be appreciated that a loss function may be used for network training. In one nonlimiting example, the peak signal-noise-ratio (PSNR) between the output and the ground truth may be used. However, this disclosure is not limited in this regard.

Thus, a deep learning system, according to the present disclosure, may be configured to solve the optimization model of Eq. (3). In particular, operations of Eqs. (16), (19), and (20), as described herein, may be implemented in a deep learning system, according to the present disclosure. Operations of a deep learning system, according to the present disclosure, may include two portions (i.e., steps). A first step may be configured to estimate a relatively low resolution (i.e., low dimensional estimation) image data based, at least in part, on a sparse sinogram. A second step may be configured to refine (i.e., high dimensional refinement) the relatively low resolution estimate based, at least in part, on the relatively low resolution estimate and based, at least in part, on the sparse sinogram. Both portions may be implemented using a reconstruction neural network architecture, according to the present disclosure.

In one embodiment, there is provided an apparatus for ultra-low-dose (ULD) computed tomography (CT) reconstruction. The apparatus includes a low dimensional estimation neural network, and a high dimensional refinement neural network. The low dimensional estimation neural network is configured to receive sparse sinogram data, and to reconstruct a low dimensional estimated image based, at least in part, on the sparse sinogram data. The high dimensional refinement neural network is configured to receive the sparse sinogram data and intermediate image data, and to reconstruct a relatively high resolution CT image data. The intermediate image data is related to the low dimensional estimated image.

FIG. 1A illustrates a functional block diagram of a deep learning system 100 for ultra-low-dose (ULD) computed tomography (CT) reconstruction, according to several embodiments of the present disclosure. Deep learning system 100 includes a reconstruction module 102, a computing device 104, and may include a training module 108. Reconstruction module 102 and/or training module 108 may be coupled to or included in computing device 104. The reconstruction network 102 is configured to receive sparse sinogram data 120 and to provide relatively high resolution CT image data as output image data 129, as will be described in more detail below. The sparse sinogram data may correspond to measured ULD CT data (as described herein) and the output image data corresponds to relatively high resolution reconstructed image data.

Reconstruction network 102 includes a filtered back projection (FBP) module 122, a low-dimensional estimation (LE) neural network (NN) 124, an up-sampling module 126, and a high-dimensional refinement neural network 128. As used herein, “neural network” and “artificial neural network” are used interchangeably and are both abbreviated as “NN”. LE NN 124 and/or HR NN 128 may include, but are not limited to, a deep ANN, a convolutional neural network (CNN), a deep CNN, a multilayer perceptron (MLP), etc. In an embodiment, LE NN 124 and/or HR NN 128 may each correspond to a respective deep neural learning module, as described herein.

Computing device 104 may include, but is not limited to, a computing system (e.g., a server, a workstation computer, a desktop computer, a laptop computer, a tablet computer, an ultraportable computer, an ultramobile computer, a netbook computer and/or a subnotebook computer, etc.), and/or a smart phone. Computing device 104 includes a processor 110, a memory 112, input/output (I/O) circuitry 114, a user interface (UI) 116, and data store 118. Processor 110 is configured to perform operations of reconstruction network 102 and/or training module 108. Memory 112 may be configured to store data associated with reconstruction network 102 and/or training module 108. I/O circuitry 114 may be configured to provide wired and/or wireless communication functionality for deep learning system 100. For example, I/O circuitry 114 may be configured to receive sparse sinogram data 120 and/or training input data 107 and to provide output image data 129. UI 116 may include a user input device (e.g., keyboard, mouse, microphone, touch sensitive display, etc.) and/or a user output device, e.g., a display. Data store 118 may be configured to store one or more of training input data 107, sparse sinogram data 120, output image data 129, network parameters associated with LE NN 124 and/or HR NN 128, and/or data associated with reconstruction module 102 and/or training module 108.

Training module 108 is configured to receive training input data 107. Training input data 107 may include, for example, a plurality of normal dose (ND) CT data records. Each ND CT data record in the training input data 107 may include an ND sinogram and corresponding reconstructed ND image data. Training module 108 may be configured to generate training data 109 that includes a plurality of training data pairs. Training module 108 may be configured to sparsify received ND sinograms. In one nonlimiting example, sparsifying may correspond to selecting fewer than all views (i.e., “few-view”) from the ND sinogram data. The corresponding training image data for the training pair may then be the ND image data that corresponds to the ND sinogram data. The ND image data may correspond to a “ground truth” (i.e., target) reconstructed image data. Thus, each training data pair included in training data 109 may include respective training (i.e., sparse) sinogram data and corresponding respective target (i.e., relatively high resolution) image data.

The reconstruction module 102 may then be trained prior to operation. Generally, training operations include adjusting network parameters 103 associated with LE NN 124 and HR NN 128 based, at least in part, on a comparison of training image data 113 to corresponding target reconstructed image data included in training data 109. With reference to Eqs. (3), (16), (19), and (20), as described herein, network parameters 103 may include, but are not limited to, step size a^{(k)}, coupling parameter b^{(k)}, nonlinear transforms Q^{(k)} and Q*^{(k)}, and step length η^{(k)}. In one example, a^{(k)} and b^{(k)} may be initialized as a⁽⁰⁾=1/∥A^{T}A+λ₁∥₂² and b⁽⁰⁾=λ₁/∥A^{T}A+λ₁∥₂² where A^{T} may be approximated by FBP.

Initially, network parameters 103, as described herein, may be initialized. Training input data 107 may be retrieved from, for example, a CT device. Training data 109 that includes a plurality of training pairs may then be generated, as described herein. A training data pair may be selected and a training sinogram 111 may be provided to the reconstruction module 102. The reconstruction module 102 may then operate and training image data 113, corresponding to output image data 129 may then be received by the training module 108 from the reconstruction module 102. The training image data may then be compared to the target reconstructed image data from the selected training pair. Network parameters 103 may then be adjusted. Training operations may repeat until a stop criterion is met, e.g., a cost function threshold value is achieved, a maximum number of iterations has been reached, etc. At the end of training, network parameters 103 may be set for operation. The reconstruction module 102 may then be configured to provide a relatively high resolution reconstructed image based, at least in part, on ULD CT input data (i.e., sparse sinogram data 120), as output data 129.

During operation (and/or training), FBP module 122, LE NN 124, and HR NN 128 are configured to receive the sparse sinogram data 120 (or training sinogram 111). FBP module 122 is then configured to performed filtered back projection on the received data to generate an FBP output 123. The FBP output 123 may then correspond to an approximation of A^{T}, as described herein with respect to Eq. (16). LE NN 124 is configured to receive the FBP output 123 and to produce an LE output 125 that corresponds to reconstructed low dimensional image data. The low dimensional image data 125 corresponds to sparse sinogram data 120 (and/or training sinogram 111). The LE output data 125 may then be provided to up-sampling module 126. Up-sampling module 126 is configured to up-sample the received LE output (i.e., low dimensional reconstructed image data) to produce intermediate image data 127. In one nonlimiting example, up-sampling may include interpolating LE image data to increase a 256 by 256 pixel image data set to a 512 by 512 pixel image data. However, this disclosure is not limited in this regard.

HR NN 128 is configured to receive the intermediate image data 127 and the input sparse sinogram data 120 (or training sinogram 111), and to generate output image data 129. Output image data 129 may then correspond to a relatively high dimensional reconstructed image.

FIG. 1B is a sketch 150 illustrating a functional block diagram 106 of a deep learning module that is one example of the neural networks 124, 128 of FIG. 1A, according to several embodiments of the present disclosure. Deep learning module 106 is one example of a SUGAR (“Split Unrolled Grid-like Alternative and/or Additional Reconstruction”) network architecture. Deep learning module 106 is configured to receive a sparse sinogram (y) 121 that corresponds to original measurement data. Sparse sinogram (y) 121 corresponds to sparse sinogram data 120 and/or training sinogram 111 of FIG. 1A. Deep learning module 106 is further configured to receive input data 105. Input data 105 may include initialization data (e.g., parameter values for iteration index k=0) and may include, for example, FBP output 123 from reconstruction module 102 of FIG. 1A (for LE NN 124), or up-sampling module output 127 (for HR NN 128).

Deep learning module 106 includes an initialization block 130, a plurality of image reconstruction modules (RMs) 132-1, 132-2, . . . , 132-K, a plurality of deep estimation modules (DMs) 134-1, 134-2, . . . , 134-K, and a plurality of error correction modules (EMs) 136-1, 136-2, . . . , 136-K. The RMs 132-1, 132-2, . . . , 132-K, DMs 134-1, 134-2, . . . , 134-K, and EMs 136-1, 136-2, . . . , 136-K are configured to implement a split Bregman technique, as described herein. Deep learning module 106 may thus be configured to implement Eqs. (16), (19), and (20), as described herein. In an embodiment, the RMs 132-1, 132-2, . . . , 132-K may correspond to Eq. (16), the DMs 134-1, 134-2, . . . , 134-K may correspond to Eq. (19), and the EMs 136-1, 136-2, . . . , 136-K may correspond to Eq. (20), where k is the iteration index and K is the total number of iterations.

The RMs 132-1, 132-2, . . . , 132-K are configured to receive the sparse sinogram 121, and to provide as output reconstructed image data, x^{(k)}. Each DM 134-1, 134-2, . . . , 134-K is configured to receive output reconstructed image data, x^{(k)}, from a respective RM 132-1, 132-2, . . . , 132-K, and to provide as output an estimated residual error, z^{(k)}, between a generated output and a reference. A first DM 134-1 and a first EM 136-1 are configured to receive an output from initialization block 130. Each EM 136-1, 136-2, . . . , 136-K is configured to receive output reconstructed image data, x^{(k)}, from a respective RM 132-1, 132-2, . . . , 132-K, and an estimated residual error, z^{(k)}, from a respective DM 134-1, 134-2, . . . , 134-K. Each EM 136-1, 136-2, . . . , 136-K is configured to provide as output a feedback error, f^{(k)}, correction.

Thus, deep learning module 106 may correspond to a SUGAR network, as described herein, and may be configured to reconstruct an input sinogram into corresponding estimated output image data.

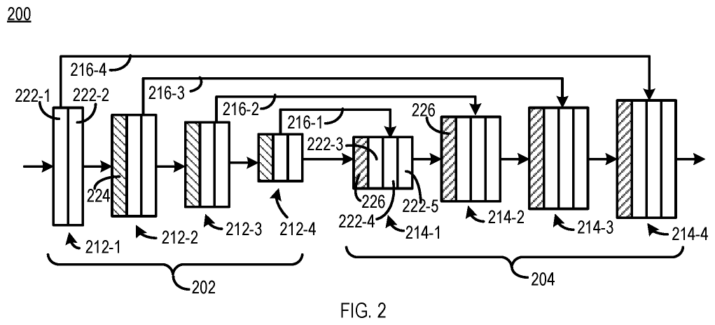

FIG. 2 illustrates a functional block diagram of an example encoder-decoder network 200, according to an embodiment of the present disclosure. Encoder-decoder network 200 is one example of the DMs 134-1, 134-2, . . . , 134-K of FIG. 1B. Encoder-decoder network 200 includes an encoder portion 202 and a decoder portion 204. The encoder portion 202 may correspond to a forward transform, Q, and the decoder portion 204 may correspond to an inverse transform Q*. The encoder portion 202 is further coupled to the decoder portion 204 by a plurality of skip connections 216-1, . . . , 216-4. Encoder-decoder network 200 may thus correspond to one example implementation of Eq. (19), as described herein.

The encoder portion 202 includes a plurality, e.g., four, forward transform blocks 212-1, . . . , 212-4, coupled in series. Each forward transform block, e.g., a first forward transform block 212-1, includes a plurality of convolutional blocks, e.g., first convolutional block 222-1, and second convolutional block 222-2. Each convolutional block includes a convolutional layer, a batch normalization (BN) layer and a rectified linear unit (ReLU). Each other forward transform block 212-2, 212-3, 212-4, i.e., other than the first forward transform block 212-1, includes a pooling block, e.g., pooling block 224 of forward transform block 212-2, prior to the first convolutional block.

The decoder portion 204 includes a plurality, e.g., four, inverse transform blocks 214-1, . . . , 214-4, coupled in series. Each inverse transform block, e.g., a first inverse transform block 214-1, includes a plurality of convolutional blocks, e.g., third convolutional block 222-3, fourth convolutional block 222-4, and fifth convolutional block 222-5. Each convolutional block includes a convolutional layer, a BN layer and a ReLU. Each inverse transform block includes an unpooling block, e.g., unpooling block 226, prior to the convolutional block.

A fourth forward transform block 212-4 is coupled to the first inverse transform block 214-1. The fourth forward transform block 212-4 is further coupled to the first inverse transform block 214-1 by a first skip connection 216-1. A third forward transform block 212-3 is coupled to a second inverse transform block 214-2 by a second skip connection 216-2. A second forward transform block 212-2 is coupled to a third inverse transform block 214-3 by a third skip connection 216-3. The first forward transform block 212-1 is coupled to a fourth inverse transform block 214-4 by a fourth skip connection 216-4.

Encoder-decoder network 200 may thus be related to one example implementation of Eq. (19), as described herein.

Thus, a deep learning system, according to the present disclosure, may be configured to solve the optimization model of Eq. (3). In particular, operations of Eqs. (16), (19), and (20), as described herein, may be implemented in a deep learning system, according to the present disclosure. The deep learning system may be trained, with the training configured to set one or more parameters associated with the deep learning system, then the trained deep learning system may be used to produce a relatively high resolution output image from sparse sinogram data corresponding to ULD CT measured data. Operations of a deep learning system, according to the present disclosure, may include two portions (i.e., steps). A first step may be configured to estimate a relatively low resolution image data based, at least in part, on a sparse sinogram. A second step may be configured to refine the relatively low resolution estimate based, at least in part, on the relatively low resolution estimate and based, at least in part, on the sparse sinogram. Both portions may be implemented using a SUGAR neural network architecture, according to the present disclosure.

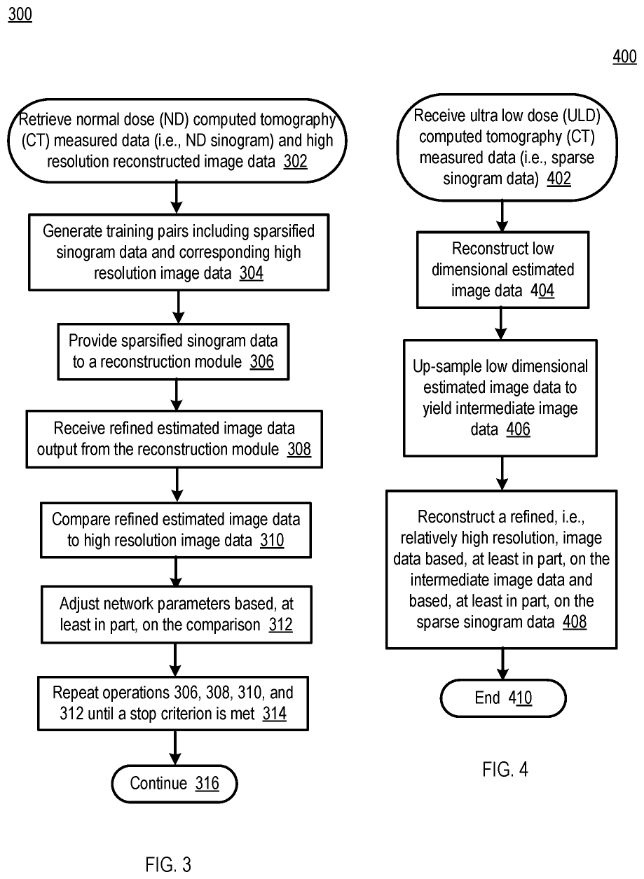

FIG. 3 is a flowchart 300 of operations for training a deep learning system for ULD CT reconstruction, according to various embodiments of the present disclosure. In particular, the flowchart 300 illustrates training a deep learning system for ultra-low dose CT image reconstruction. The operations may be performed, for example, by the deep learning system 100 (e.g., reconstruction network 102, deep learning module 106, and/or training module 108) of FIGS. 1A, and 1B.

Operations of this embodiment may begin with retrieving ND CT measured data (i.e., ND sinogram) and high resolution reconstructed image data at operation 302. Operation 304 includes generating training pairs including sparsified sinogram data and corresponding high resolution image data. Operation 306 includes providing sparsified sinogram data to a reconstruction module, e.g., reconstruction module 102 of FIG. 1A. Operation 308 includes receiving refined estimated image data output from the reconstruction module. Operation 310 includes comparing refined estimated image data to high resolution image data. Operation 312 includes adjusting network parameters based, at least in part, on the comparison. Operation 314 includes repeating operations 306, 308, 310, and 312, until a stop criterion is met. Program flow may then continue at operation 316.

Thus, a deep neural network may be trained and may then be configured to receive sparse sinogram data as input and to provide relatively high resolution CT image data as output.

FIG. 4 is a flowchart of operations for AI-enabled ULD CT reconstruction, according to various embodiments of the present disclosure. In particular, the flowchart 400 illustrates producing relatively high resolution image data corresponding to a sparse sinogram input. The operations may be performed, for example, by the deep learning system 100 (e.g., reconstruction network 102, and/or deep learning module 106) of FIGS. 1A, and 1B.

Operations of this embodiment may begin with receiving ULD CT measured data (i.e., sparse sinogram data) at operation 402. Operation 404 may include reconstructing low dimensional estimated image data. Operation 406 may include up-sampling the low dimensional estimated image data to yield intermediate image data. Operation 408 may include reconstructing a refined, i.e., relatively high resolution, image data based, at least in part, on the intermediate image data and based, at least in part, on the sparse sinogram data. Program flow may then end at operation 410.

Thus, a deep neural network may be configured to receive sparse sinogram data and to reconstruct the sparse sinogram data into relatively high resolution CT image data.

### Experimental Data

To validate the feasibility of ultra-low-dose CT imaging, clinical experiments were performed on 2016 NIH-AAPM-Mayo Low-dose CT Grand Challenge datasets (available from the AAPM (American Association of Physicists in Medicine), Alexandria, Virginia, United States). The datasets were obtained from Siemens Somatom Definition CT scanners at 120k Vp (kilovoltage peak) and 200 mAs (milliampere-seconds). The original scans were in helical cone-beam geometry, thus the experimental data was sorted into a plurality of slice fan-beam datasets. A single slice rebinning operation was employed and that took the flying focal spot into account. The imaging parameters included: the distances from x-ray source to detector and the system isocenter, the number of units in the curved cylindrical detector, the coverage area of each detector, the number of views in a scan, the distribution of projections in a scan, extraction details of projections to generate ultra-low-dose projections, detector shift, a size of a reconstructed image, and a coverage area of each pixel. The distances from x-ray source to detector and the system isocenter were 1085.6 mm (millimeters) and 595 mm, respectively. The curved cylindrical detector contained 736 units, each of which covered an area of 1.2858×1.0 mm², and there were 2304 views in a scan. 946 projections were uniformly distributed over 151.875°. 36 projections were extracted from the above 946 projections by selecting one per 28 projections to generate ultra-low-dose projections. The detector shift was 0.0013 radian. The size of a reconstructed image was set to 512×512 pixels, each of which covered 0.9×0.9 mm². A total number of 4,665 sinograms of 2,304×736 pixels were acquired from 10 patients at a normal dose setting, where 4,274 sinograms of 8 patients were employed for network training, and the remaining 391 sinograms from the other 2 patients for network testing.

Peak signal to noise ratio (PSNR) was employed as the cost function configured to measure a difference between reconstructed images and a reference (i.e., “ground truth”). In one nonlimiting example, the reconstructed image using FBP with full-scan projections was configured as the ground truth. Additionally or alternatively, the structural similarity (SSIM) index was used to compare between the reconstructed images and the reference. However, this disclosure is not limited in this regard.

An Adam method was employed to optimize all of the networks. However, this disclosure is not limited in this regard. To avoid inconsistency in size between feature maps and the input, zeros were padded around the boundaries before convolution. The batch size for LE NN and HR NN was set to 1. The learning rate was decreased with the number of epochs. In one nonlimiting example, the number of epochs was set to 40 for all the networks. The learning rate was set to 2.5×10⁻⁴, and decreased by 0.8 after each of 5 epochs. In this example, the number of iterations for LE and HR networks were set to 70 and 30, respectively. In the testing process, 391 images were selected from two patients (L109, 291 slices; and L291, 100 slices).

It may be appreciated that a deep learning based SUGAR technique, according to the present disclosure, can achieve relatively high-quality images. An apparatus, method and/or system according to the present disclosure may recover relatively high resolution CT images in two steps: LE and HR. Advantageously, an apparatus, method and/or system according to the present disclosure may (1) reduce or remove a burden of the selection of parameters in specific applications; (2) reduce a computational cost for relatively fast imaging; and (3) achieve a reconstruction quality gain. For example, the encoder-decoder neural block may facilitate transforms between data and image domains, where the sampling processes are implemented as multiple-level down-sampling convolutional layers for feature extraction and up-sampling convolutional operators for image reconstruction

As used in any embodiment herein, the terms “logic” and/or “module” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may include, for example, singly or in any combination, hardwired circuitry, programmable circuitry such as computer processors comprising one or more individual instruction processing cores, state machine circuitry, and/or firmware that stores instructions executed by programmable circuitry. The logic and/or module may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

Memory 112 may include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1. An apparatus for ultra-low-dose (ULD) computed tomography (CT) reconstruction, the apparatus comprising:
a low dimensional estimation neural network configured to receive sparse sinogram data, and to reconstruct a low dimensional estimated image based, at least in part, on the sparse sinogram data; and
a high dimensional refinement neural network configured to receive the sparse sinogram data and intermediate image data, and to reconstruct a relatively high resolution CT image data, wherein the intermediate image data is related to the low dimensional estimated image.

2. The apparatus of claim 1, wherein each neural network comprises an image reconstruction module (RM), a deep estimation module (DM), and an error correction module (EM).

3. The apparatus of claim 1, wherein each neural network is configured to implement a split-Bregman technique.

4. The apparatus according to claim 1, further comprising a filtered back projection (FBP) module configured to produce an FBP output based, at least in part, on the sparse sinogram data, the low dimensional estimated image reconstructed based, at least in part, on the FBP output.

5. The apparatus according to claim 1, further comprising an up-sampling module configured to produce the intermediate image data based, at least in part, on the low dimensional estimated image.

6. The apparatus according to claim 1, wherein the low dimensional estimation neural network and the high dimensional refinement neural network are trained based, at least in part, on normal dose (ND) CT image data.

7. The apparatus of claim 2, wherein
$$the R M corresponds to {x}^{( k + 1 )} = {x}^{( k )} - {a}^{( k )} ( {A}^{T} ( {Ax}^{( k )} - y ) ) - {b}^{( k )} ( {x}^{( k )} - {z}^{( k )} - {f}^{( k )} ) ,$$
$$the D M corresponds to {z}^{( k + 1 )} = Q * ( {z}_{1}^{( k )} ) = Q * ( Q ( {x}^{( k + 1 )} - {f}^{( k )} ) ) , and$$
$$the E M corresponds to {f}^{( k + 1 )} = {f}^{( k )} - {η}^{( k + 1 )} ( {x}^{( k + 1 )} - {z}^{( k + 1 )} ) .$$

8. A method for ultra-low-dose (ULD) computed tomography (CT) reconstruction, the method comprising:
reconstructing, by a low dimensional estimation neural network, a low dimensional estimated image based, at least in part, on sparse sinogram data; and
reconstructing, by a high dimensional refinement neural network, a relatively high resolution CT image data based, at least in part, on the sparse sinogram data and based, at least in part, on intermediate image data, wherein the intermediate image data is related to the low dimensional estimated image.

9. The method of claim 8, wherein each neural network comprises an image reconstruction module (RM), a deep estimation module (DM), and an error correction module (EM).

10. The method of claim 8, wherein the reconstructing by the neural networks comprises implementing a split-Bregman technique.

11. The method of claim 8, further comprising producing, by a filtered back projection (FBP) module, an FBP output based, at least in part, on the sparse sinogram data, the low dimensional estimated image reconstructed based, at least in part, on the FBP output.

12. The method of claim 8, further comprising producing, by an up-sampling module, the intermediate image data based, at least in part, on the low dimensional estimated image.

13. The method of claim 8, further comprising training, by a training module, the low dimensional estimation neural network and the high dimensional refinement neural network based, at least in part, on normal dose (ND) CT image data.

14. A deep learning system for ultra-low-dose (ULD) computed tomography (CT) reconstruction, the deep learning system comprising:
a computing device comprising a processor, a memory, an input/output circuitry, and a data store; and
a reconstruction module comprising a low dimensional estimation neural network, and a high dimensional refinement neural network, the low dimensional estimation neural network configured to receive sparse sinogram data, and to reconstruct a low dimensional estimated image based, at least in part, on the sparse sinogram data, the high dimensional refinement neural network configured to receive the sparse sinogram data and intermediate image data, and to reconstruct a relatively high resolution CT image data, wherein the intermediate image data is related to the low dimensional estimated image.

15. The deep learning system of claim 14, wherein each neural network comprises an image reconstruction module (RM), a deep estimation module (DM), and an error correction module (EM).

16. The deep learning system according to claim 14, wherein each neural network is configured to implement a split-Bregman technique.

17. The deep learning system according to claim 14, wherein the reconstruction module comprises a filtered back projection (FBP) module configured to produce an FBP output based, at least in part, on the sparse sinogram data, the low dimensional estimated image reconstructed based, at least in part, on the FBP output.

18. The deep learning system according to claim 14, wherein the reconstruction module comprises an up-sampling module configured to produce the intermediate image data based, at least in part, on the low dimensional estimated image.

19. The deep learning system according to claim 14, wherein the low dimensional estimation neural network and the high dimensional refinement neural network are trained based, at least in part, on normal dose (ND) CT image data.

20. A computer readable storage device having stored thereon instructions that when executed by one or more processors result in the following operations comprising the method according to claim 8.
